(19) United States
(12) Patent Application Publication
(10) Pub. No.: US 2014/0232868 A1
(43) Pub. Date: Aug. 21, 2014

(54) CAMERA SYSTEM FOR USE IN A VEHICLE AS WELL AS A VEHICLE HAVING SUCH A CAMERA SYSTEM

(71) Applicants: Axel Schwarz, Baden-Baden (DE); Bruno Hodapp, Achern-Oensbach (DE); Henry Blitzke, Buehl (DE); Andreas Pack, Hagenau (FR)

(72) Inventors: Axel Schwarz, Baden-Baden (DE); Bruno Hodapp, Achern-Oensbach (DE); Henry Blitzke, Buehl (DE); Andreas Pack, Hagenau (FR)

(21) Appl. No.: 14/131,889

(22) PCT Filed: Jul. 9, 2012
(86) PCT No.: PCT/EP2012/063426

§ 371 Date: Apr. 21, 2014

(30) Foreign Application Priority Data
Jul. 12, 2011 (DE) 102011078996.0
Mar. 28, 2012 (DE) 102012205012.4

(51) Int. Cl. H04N 7/18

(52) U.S. Cl. CPC H04N 7/181
USPC 348/148

(57) ABSTRACT

A camera system for use in a vehicle for simultaneously recognizing rain on its windshield and for monitoring the surroundings, includes: a camera having a camera lens and an image sensor, a mirror system having at least one first mirror and at least one second mirror which are situated in such a way that they define a beam path from a monitored area of the windshield to the first mirror, from there to the second mirror, and from there through the camera lens to a first subarea of the image sensor, the distance along the beam path between the at least one second mirror and the camera lens being smaller than the distance along the beam path between the at least one second mirror and the monitored area.

### BACKGROUND OF THE INVENTION

1. Field of the Invention

The present invention relates to a camera system for use in a vehicle for simultaneously recognizing rain on its windshield and monitoring the surroundings, as well as to a vehicle having such a camera system.

2. Description of the Related Art

The use of camera systems in vehicles for monitoring the surroundings is basically known. For example, such camera systems are used to monitor and evaluate the surroundings with regard to traffic signs. Lane monitoring and cruise control with regard to surrounding objects have also been already carried out with the aid of camera systems. Moreover, it is known to use rain sensors in order to control the wiper activity on the windshield of a vehicle.

The problem with the known systems is that the camera system for monitoring the surroundings is implemented separately from the rain sensor. On the one hand, this increases the complexity of the overall system, and on the other hand, its costs. A combination of recognizing rain drops on the windshield for controlling a wiper using a known camera system is not known so far. Also, such a combination would result in problems, since for monitoring the surroundings, a focus range between 3 meters and 30 meters is necessary and for monitoring the windshield, a close focus range ahead of the camera is necessary. The close range is in this case in particular defined as a distance of 10 cm to 50 cm, e.g., 30 cm, ahead of the camera.

It is, in particular, problematic in this case that a sufficiently wide area of the windshield must be monitored in order for the camera to recognize rain on the windshield. A relatively great distance between the camera and the windshield is necessary to ensure that, which, in turn, contradicts the known installation places for such camera systems and thus the structural requirements.

It is the object of the present invention to eliminate the previously mentioned disadvantages of known systems for recognizing rain on the windshield and for monitoring the surroundings of vehicles. In particular, it is the object of the present invention to provide a camera system for a vehicle as well as a vehicle having a camera system which is capable of simultaneously recognizing rain on the windshield of the vehicle and monitoring its surroundings, while requiring a small installation space.

### BRIEF SUMMARY OF THE INVENTION

A camera system according to the present invention is designed for use in a vehicle for simultaneously recognizing rain on its windshield and for monitoring the surroundings. It has a camera having a camera lens and an image sensor. The camera lens may in this case provide different complex optical devices to guide incident light onto the image sensor. The image sensor is advantageously a digital image sensor which may record still images or also moving images. Here, the camera itself may already be equipped with an evaluation device for generating the image or also be connected with such a device in such a way that signal communication may take place between them.

A camera system according to the present invention furthermore has a mirror system having at least one first mirror and at least one second mirror. Subsequently, the present invention is partially described based on a first and a second mirror. The following description, however, also includes camera systems having at least one second mirror and at least one first mirror. These mirrors are situated in such a way that they define a beam path from a monitored area of the windshield to the first mirror, from there to the second mirror, and from there, through the camera lens, onto a first subarea of the image sensor. In other words, an image of a monitored area of the windshield is generated on the image sensor through the beam path. Here, the monitored area, however, takes up in its image on the image sensor only a first subarea. The remaining area of the image sensor thus remains available for a primary task of the camera. It is therefore possible to carry out the recognition of rain on the vehicle's windshield, in particular for the monitored area of the windshield, in the first subarea of the image sensor. The remaining area is used to carry out a primary function, i.e., for example, to monitor the surroundings of the vehicle, in particular to carry out a traffic sign recognition, a cruise control, or a lane keeping assistant.

To be able to produce a camera system according to the present invention having the smallest possible installation space, the distance along the beam path between the at least one second mirror and the camera lens is smaller according to the present invention than the distance along the beam path between the at least one second mirror and the monitored area. This means that the distance which a light beam travels starting from the monitored area to the second mirror is longer than the distance which this light beam travels subsequently from the second mirror to the camera lens. The distance between the monitored area and the second mirror passes the first mirror and the beam is deflected.

Due to the design according to the present invention of this distance ratio, it is possible that the second mirror may be situated very closely in front of the camera lens. The camera lens and the second mirror thus require a very small installation space when combined. Since it is important for an image of a particularly large monitored area of the windshield that the distance between the second mirror and this monitored area is selected to be as large as possible, the first mirror may essentially be situated freely in the area of the beam path between the second mirror and the monitored area. In other words, it is irrelevant for the present invention in a first step in which way the distance is divided into partial distances between the monitored area and the first mirror as well as between the first mirror and the second mirror. In particular, the distance along the beam path between the at least one second mirror and the camera lens is, however, smaller than the distance between the at least one second mirror and the at least one first mirror and/or smaller than the distance between the at least one first mirror and the monitored area.

In particular, a division of the overall distance of the beam path is carried out as follows. If the overall beam path is defined as a distance of 100%, less than 20%, in particular less than 15%, in particular preferably less than 10%, of the overall distance is advantageously attributed to the beam path between the second mirror and the camera lens. This results in a division ratio of 20:80, or 15:85, or 10:90.

As a result of the above-described division, i.e., the minimization of the distance between the second mirror and the camera lens, it may be achieved despite the small installation space that a correspondingly large distance between the second mirror and the windshield is traveled due to the further deflection with the aid of the first mirror. By being able to freely place the first mirror, it is, in turn, possible to situate the first mirror in particular also in close proximity, i.e., at a short distance in the direction of the beam path, of the second mirror. Accordingly, the camera and mirror system may together form a compact unit which is situatable together closely to the ceiling of a vehicle, for example. Despite this compact design, a relatively long distance is implementable between the second mirror and the monitored area of the windshield. This enlarges the entire monitored area and improves the depth of field for this image. In other words, it is possible due to the enlargement of the distance between the second mirror and the monitored area of the windshield to obtain a sufficiently large monitored area, so that one single camera is desirably able to carry out on one single image sensor both functions, namely recognizing rain on the windshield and monitoring the surroundings. In particular, the camera system according to the present invention is a mirror system which is able to guide the beams along the beam path essentially in parallel, i.e., in particular afocally, to the camera lens starting from the second mirror.

The first subarea of the image sensor may be pronounced more or less strongly. It is thus possible that the first subarea of the image sensor fills up 5% to 20% of the overall area of the image sensor. If, for example, an image sensor having a resolution of 500 lines is used, 50 lines may, for example, be defined as a first subarea on which the beam path is guided via the mirror system of a camera system according to the present invention. The separation between the subareas on the image sensor is in this case as focused as possible, so that no or essentially no superimposition of the images from the recognition of rain on the windshield and the monitoring of the surroundings of the vehicle takes place.

The definition of the distance along the beam path is in this case understood to mean the distance which in particular represents the averaged distance of a beam along the beam path between the individual structural components. In particular, in each case a distance is defined between the individual structural components, i.e., the monitored area, the at least one first mirror, and at least one second mirror as well as the camera lens.

The distance between the second mirror and the camera lens is in this case advantageously minimized, i.e., reduced to a structural minimum. Since, due to the beam path between the second mirror and the camera lens being essentially parallel, i.e., afocal, this is a beam path which has no influence on the enlargement of the area on the windshield to be monitored, a minimization is possible for purely structural reasons. According to the present invention, the second mirror is therefore situatable very closely to the camera lens, so that the entire installation space for a camera system according to the present invention may be minimized in this way.

Within the scope of the present invention, the term “windshield” may be understood to mean all windows of a vehicle. In addition to the front window of a vehicle through which the driver may observe the road in front of the vehicle, other windows of the vehicle, such as the rear window, the side windows, or the sliding roofs are accordingly conceivable as windshields within the scope of the present invention. Preferably, however, the front window of the vehicle is involved.

The monitored area on the windshield may be directly in front of the camera system or also be offset to it in a camera system according to the present invention. If the camera system is, for example, in the center of the windshield and close to a rear-view mirror of a vehicle, it is possible that the monitored area is situated directly ahead of the camera system or directly below the camera system. However, it is also possible that the area monitored via the mirror system is in an area of the windshield, in particular in one of the corners of the windshield, which is at a distance from it. This has the advantage that due to this asymmetric configuration of the individual mirrors of the mirror system, the distance between the second mirror and the monitored area on the windshield may be even further maximized, without the need for structural changes to the camera system. Thus, the advantages according to the present invention may be achieved in an improved manner by an asymmetric configuration of the mirror system.

It may be advantageous when, in a camera system according to the present invention, the mirror system is designed in such a way that the beam path between the at least one second mirror and the camera lens runs in parallel or almost in parallel. A parallel beam path is understood to mean a so-called afocal beam path. This means that an image is projected on the image sensor in infinity, so to speak. This improved optics allows the beams obtained from the monitored area of the windshield to be coupled into the camera in an optically optimum manner.

Another advantage is when, in a camera system according to the present invention, at least one of the mirrors has a curvature, in particular a spherical curvature. The provision of such a curvature allows beams to be captured and parallelized which are not afocal, i.e., not parallel. This makes it possible to generate an essentially parallel or completely parallel beam path between the at least one second mirror and the camera lens. Moreover, the monitored area of the windshield may be enlarged in this way without changing the distance between the curved mirror and this monitored area. In other words, the monitored area may be expanded in two ways, namely on the one hand by providing a curvature for at least one of the two mirrors, and on the other hand by enlarging the distance between the at least one second mirror and the monitored area of the windshield.

Another advantage is when, in a camera system according to the present invention, an illumination system is provided which is designed in such a way that it may illuminate the monitored area of the windshield at least sectionally. An LED light source, in particular with the aid of a glow stick, is conceivable for such an illumination system, for example. It is to be used for night drives or when the outside light is not sufficient to provide sufficient light for the monitored area, so that a recognition of rain on the windshield is also possible during night drives or bad lighting conditions by using the illumination system.

In a camera system according to the present invention, such an illumination system, if used, is advantageously situated on at least one of the two mirrors. The placing advantageously takes place in such a way that the mirror surfaces of the two mirrors are not or preferably hardly illuminated. In other words, the illumination takes place independently of the beam path which is defined by the mirror system itself.

It may also be advantageous when, in a camera system according to the present invention, the at least one second mirror is located within a detection area of the camera system defined by the camera. In this way, the at least one second mirror blocks, so to speak, apart of this detection area which is also referred to as the field of view. This area of the detection area which is blocked by the at least one second mirror is therefore no longer accessible for the primary perception of the camera. This maybe advantageous when a particularly sharp separation of the individual subareas on the image sensor is desirable. In this way, superimposition effects on the sub-areas maybe avoided or at least reduced. The evaluation of the individual pieces of image information, in particular of those in the first subarea of the image sensor, is improved in this way.

It may also be advantageous when, in a camera system according to the present invention, the at least one first mirror is completely or essentially completely outside of this detection area. In this way, the first mirror may be implemented independently of the detection area of the camera via the two mirrors of a mirror system according to the present invention, so that the detection area is not impaired.

It is also advantageous when, in a camera system according to the present invention, the first subarea of the image sensor takes up an area between 5% and 30%, in particular between 7% and 15%, of the entire sensor area of the image sensor. This then means that the main area of the image sensor, i.e., the second or the other subareas of the same, remain available for the primary use.

A camera system according to the present invention may be refined in such a way that the camera lens is designed in such a way that the beam paths from at least one second mirror through the camera lens and the beam paths for monitoring the surroundings through the camera lens on the image sensor do not overlap or do essentially not overlap. In other words, a particularly sharp separation of the individual subareas on the image sensor is thus desirable. An overlapping of the individual subareas and accordingly an overlapping of the images present in each case are reduced or avoided in this way. In particular, this is advantageous since in the overlapping areas, either a more complex evaluation would have to take place or these overlapping areas would not be available for evaluation at all.

Likewise, the object of the present invention is a vehicle having a windshield and a camera system according to the present invention. Such a vehicle accordingly offers the same advantages as elucidated previously in detail for a camera system according to the present invention.

Subsequently, the present invention is described again briefly in other words. A configuration according to the present invention of a camera system allows the optical preconditions for the camera system to be met, while requiring a small installation space. In particular, the compact mirror system of the camera system according to the present invention has the advantage that an illumination system may also be integrated very efficiently. The optically relevant distance between the windshield and the second mirror may be extended even further when the second and/or the first mirror are placed on the left or on the right next to the camera lens, whereby an asymmetric configuration results in the horizontal perspective. Such an asymmetric configuration is in particular advantageous for a camera having an asymmetric camera body. In this case, the mirrors may have a significantly more complex design. In particular, the mirrors are designed as free formed surfaces in such a specific embodiment.

With the aid of a camera system according to the present invention for a vehicle, in particular a passenger car or a semi-truck, a preferably wide, focused monitored area on the windshield of the vehicle and a very good resolution maybe achieved at the same time for optical reasons. This is achieved by the great distance between the windshield surface and the at least one second mirror of the camera system. Moreover, the present invention makes a particularly small installation space achievable, whereby the applicability of a camera system according to the present invention in a vehicle is further increased.

Other measures which enhance the present invention are illustrated in greater detail below based on the figures together with the description of the preferred exemplary embodiments of the present invention. The terminology “left,” “right,” “top,” and “bottom” used here refer to an orientation of the figures of the drawing having normally readable reference numerals.

### BRIEF DESCRIPTION OF THE DRAWINGS

FIG. 1 shows in a schematic cross section a first specific embodiment of a camera system according to the present invention.

FIG. 2 shows another specific embodiment of a camera system according to the present invention in a schematic cross section.

FIG. 3 shows one schematic representation of the image on an image sensor.

FIG. 4 shows one specific embodiment of a motor vehicle according to the present invention.

### DETAILED DESCRIPTION OF THE INVENTION

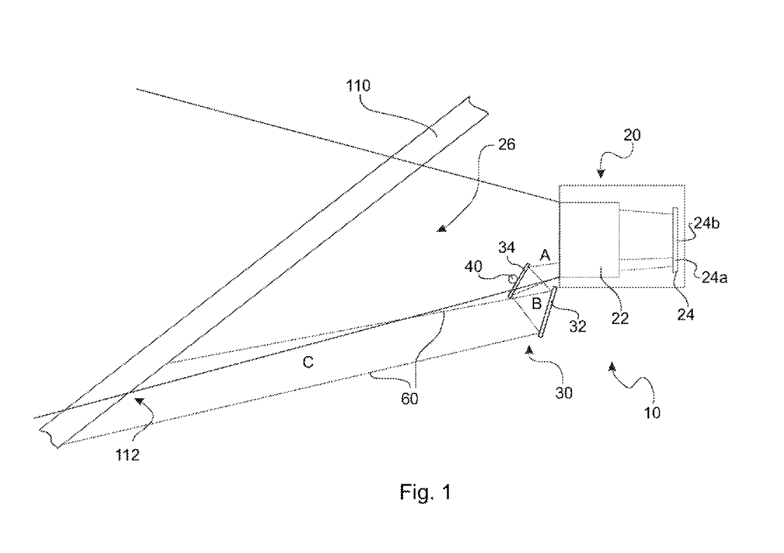

A first specific embodiment of a camera system 10 according to the present invention is illustrated in FIG. 1. In this specific embodiment, a camera 20 is provided inside a vehicle 100. Camera 20 has a camera lens 22 and an image sensor 24. Camera lens 22 is, for example, equipped with different optical lenses to guide incident light onto image sensor 24. Camera 20 is assignable a detection area 26 which is also referred to as a “field of view.” On the one hand, this depends on the design of image sensor 24 and on the other hand, this depends on the design of camera lens 22.

A camera 20 of this specific embodiment has the primary task of monitoring the surroundings of vehicle 100 through windshield 110. The monitoring may, for example, be used for controlling an adaptive cruise control, a lane keeping assistance system, or a traffic sign monitoring system.

Due to a secondary function of camera 20, a camera system 10 according to the present invention is designed in such a way that it allows for rain detection on windshield 110 in this specific embodiment. This is carried out as follows.

A mirror system 30 has a first mirror 32 and a second mirror 34. These mirrors are situated in such a way that three partial distances A, B, and C result. Partial distance A is between second mirror 34 and camera lens 22. Partial distance B is between the two mirrors 32 and 34. Distance C is between first mirror 32 and a monitored area 112 on windshield 110. These three distances have different effects for the imaging onto first subarea 24a of image sensor 24.

Distance A is a distance which is part of beam path 60 which has essentially parallel beams, i.e., afocal beams. This is used, in particular, for optimally coupling these beams into camera lens 22. Distance segments B and C are, in particular, not parallel, i.e., partially scattered. This results in monitored area 112 being enlarged due to the expansion of the beam path between first mirror 32 and monitored area 112 of windshield 110 as well as between the two mirrors 32 and 34.

In particular, a compact design of entire camera system 10 is achieved due to the compact configuration of the two mirrors 32 and 34 close to camera 20, a sufficiently great distance being simultaneously kept between second mirror 34 and monitored area 112. Therefore, it is essential for the present invention that distance A is minimized, while the sum of distances B and C is maximized. In this case, the distribution between distances B and C is irrelevant. However, it is advantageous when distance B is also selected to be small, so that both mirrors 32 and 34 may be situated close to camera 20 as a result. This design makes it possible, for example, to provide one single housing which accommodates both camera 20 and mirror system 30. Distance B advantageously corresponds to distance A.

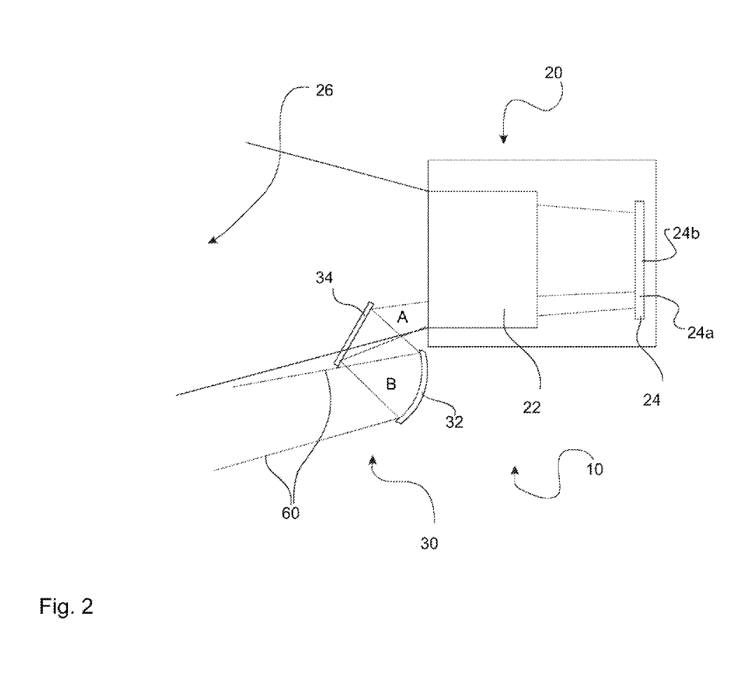

FIG. 2 shows one alternative specific embodiment to the specific embodiment of FIG. 1. The difference here is that one of the two mirrors 32 and 34, namely first mirror 32, is designed as a spherical mirror. Naturally, it is also possible that the two mirrors 32 and 34, or also only second mirror 34, are designed as spherical mirrors. The curvature of at least one of the two mirrors does not necessarily have to be spherical, but may also have a more complex shape. The basic provision of such a curvature results in beam path 60 between second mirror 34 and monitored area 112 being enlarged. In the specific embodiment of FIG. 2, the beam path is in an essentially parallel or afocal state between the two mirrors 32 and 34 as well as between second mirror 34 and camera lens 22. In addition to great distance C, the enlargement of beam path 60 has the effect that monitored area 112 is further enlarged, while the depth of field remains constant.

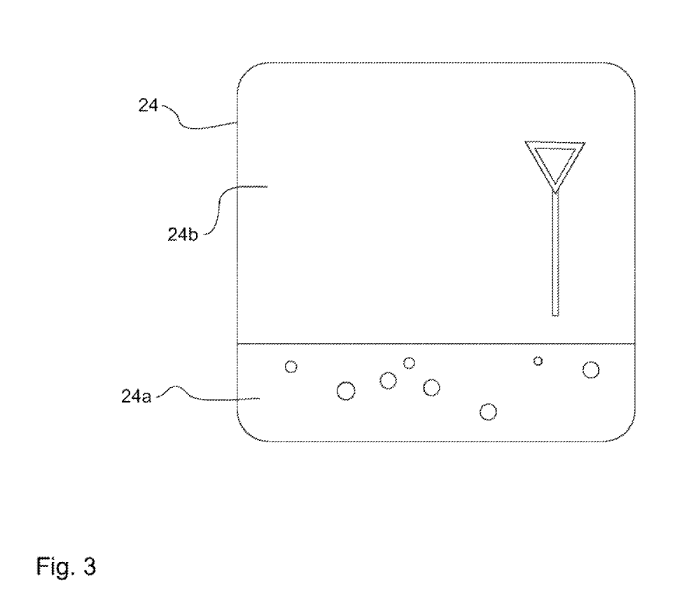

FIG. 3 illustrates an example of the image on image sensor 24 of a camera system 10. First subarea 24a is imaged by monitored area 112 from beam path 60 via mirror system 30. Second subarea 24b is imaged from the primary function, i.e., from direct monitoring, with the aid of camera 20. As an example, a traffic sign is illustrated in second subarea 24b, and rain drops from monitored area 112 of windshield 110 are illustrated in first subarea 24a. An evaluation device (not illustrated) is used to evaluate the two subareas together or independently of one another. The border between subareas 24a and 24b is to be drawn here as clearly as possible. Possible overlapping areas between the two images are advantageously filtered out during the evaluation of the images.

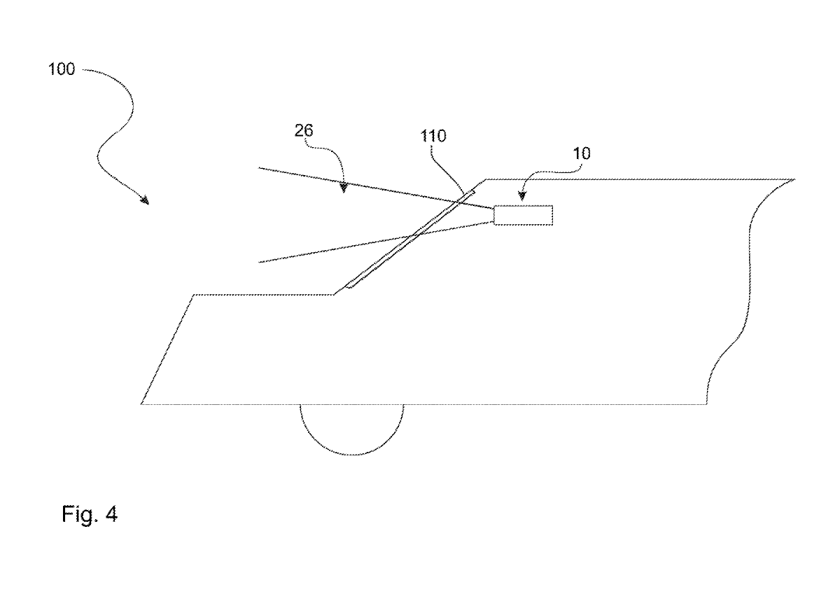

FIG. 4 shows a vehicle 100 according to the present invention according to a first specific embodiment. A camera system 10 according to the present invention, in particular according to one of the specific embodiments of FIGS. 1 and 2, is situated inside the vehicle behind windshield 110. This windshield 110 is the front window of vehicle 10. Camera system 10 is situated in such a way that its detection area 26 may record the surroundings of vehicle 100 through windshield 110 as well as a monitored area 112 on windshield 110.

The above-mentioned specific embodiments describe the present invention within the scope of examples. Naturally, features of the individual specific embodiments may be combined freely with one another, if it makes sense technologically, without departing from the scope of the present invention.

1-10. (canceled)

11. A camera system positioned in a vehicle for simultaneously recognizing rain on a windshield of the vehicle and for monitoring the surroundings of the vehicle, comprising:
a camera having a camera lens and an image sensor; and
a mirror system having at least one first mirror and at least one second mirror which are situated in such a way to define a beam path from a monitored area of the windshield to the first mirror, from the first mirror to the second mirror, and from the second mirror through the camera lens to a first subarea of the image sensor;
wherein the distance along the beam path between the at least one second mirror and the camera lens is smaller than the distance along the beam path between the at least one second mirror and the monitored area.

12. The camera system as recited in claim 11, wherein the mirror system is configured in such a way that beams transmitted along the beam path between the at least one second mirror and the camera lens are essentially parallel.

13. The camera system as recited in claim 12, wherein at least one of the mirrors has a spherical curvature.

14. The camera system as recited in claim 13, further comprising:
an illumination system configured to selectively illuminate at least a portion of the monitored area of the windshield.

15. The camera system as recited in claim 14, wherein the illumination system is situated on at least one of the two mirrors.

16. The camera system as recited in claim 14, wherein the at least one second mirror is located within a detection area defined by the camera.

17. The camera system as recited in claim 16, wherein the at least one first mirror is located essentially completely outside of the detection area defined by the camera.

18. The camera system as recited in claim 14, wherein the first subarea of the image sensor takes up an area between 5% and 30% of entire sensor area of the image sensor.

19. The camera system as recited in claim 14, wherein the camera lens is configured in such a way that the beam path from the at least one second mirror through the camera lens and the beam path for monitoring the surroundings through the camera lens on the image sensor do not overlap.
